(19) United States
(12) Patent Application Publication
(10) Pub. No.: US 2009/0068382 A1
(43) Pub. Date: Mar. 12, 2009

(54) Happy shell

(76) Inventor: Andrew Kitchen, Avondale, AZ (US)

Correspondence Address: ANDREW KITCHEN, 10406 WEST SUNFLOWER, AVONDALE, AZ, 85323, US

(21) Appl. No.: 12/154,446

(22) Filed: Nov. 7, 2008

Related U.S. Application Data
(63) Continuation-in-part of application No. 11/890,231, filed on Aug. 6, 2007, now abandoned.

(51) Int. Cl. B44F 7/00

(52) U.S. Cl. 428/16

(57) ABSTRACT

The invention portrays a smiley face on clam shells created by applying colored glittery sparkles instead of paint or drawing. The invention has unique depth considering the two clam shell design for easier identification.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention relates to a beach artwork that is made of clam shells, glitter sparkles, glue and adhesive. Inexpensive materials of the invention bring beach art work to more people at an affordable price.

### BRIEF SUMMARY OF THE INVENTION

The invention is inexpensive beach art work that has low production cost. The object of the invention is to bring happiness, smiling faces, and unforgotten memories. Another object is bringing affordable beach artwork to the market place.

### BRIEF DESCRIPTION OF THE SEVERAL VIEWS OF THE DRAWING

FIG. 1 is a front view of a Happy Shell,

FIG. 2 is a back view of a Happy Shell

FIG. 3 is a side view of a Happy Shell

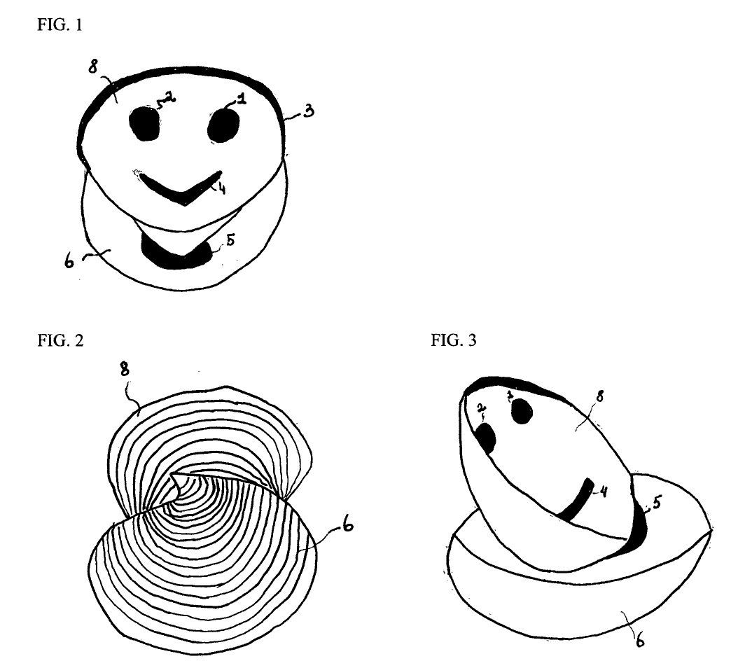

### DETAILED DESCRIPTION OF THE INVENTION

A happy shell invention is composed of two upward facing inversely laid and glued clam shells. The top clam shell portraying a smiley face (8) glued forward facing inside another clam shell (6) which is used as a support. The smiley face (eyes, mouth and hair) is glitter applied to the top inner face of the clam shell.

The invention is different from the typical smiley face in that it is not created by drawing or painting the face but using other art materials. The invention is also different by using two clam shells attached at horizontal and vertical angles on top of each other creating depth of this three-dimensional art piece compared to other artwork which is two-dimensional. The depth created by the two glued clam shells opens a future to accessorizing the Happy Shell.

1. What I claim as my invention is: an open clam shell used as a base and support for a second clam shell portraying artwork.

2. What I claim as my invention is: a top forward facing vertical inner clam shell portraying artwork mounted on top of the inside of another horizontal clam shell.
